(19) United States
(12) Patent Application Publication
(10) Pub. No.: US 2026/0165244 A1
(43) Pub. Date: Jun. 18, 2026

(54) WEAR RING FOR EXTRACTOR OF A SUGARCANE HARVESTER

(71) Applicant: Deere & Company, Moline, IL (US)

(72) Inventor: BLAIN J. CAZENAVE, Thibodaux, LA (US)

(21) Appl. No.: 18/982,437

(22) Filed: Dec. 16, 2024

(51) Int. Cl. A01D 45/10; A01D 61/00

(52) U.S. Cl. CPC A01D 45/10; A01D 61/008

(57) ABSTRACT

An extractor for a sugarcane harvester includes a housing including an inlet and an outlet, the inlet configured to receive a stream of chopped sugarcane including crop debris and billets, and the outlet configured to discharge the crop debris. A fan assembly is located in the housing and includes a plurality of fan blades coupled to a spindle. A wear ring surrounds the fan blades, the wear ring including a cylindrical wall, the cylindrical wall including a full height portion circumscribing at least one-half of a circumference of the cylindrical wall and an exit opening defined in an arcuate reduced height portion of the cylindrical wall, the exit opening being oriented towards the outlet of the housing.

### BACKGROUND OF THE DISCLOSURE

### 1. Field of the Disclosure

The present invention generally relates to a harvesting machine, and more particularly to an improved wear ring for an extractor of a sugarcane harvesting machine.

### 2. Description of the Prior Art

Agricultural equipment, such as a tractor or a self-propelled harvester, includes mechanical systems, electrical systems, hydraulic systems, and electro-hydraulic systems, configured to prepare fields for planting or to harvest crops.

Harvesters of various configurations, including sugarcane harvesters, have harvesting systems of various types. Harvesting systems for a sugarcane harvester, for example, include assemblies or devices for cutting, chopping, sorting, transporting, etc., and otherwise gathering and processing sugarcane plants. Typical harvesting assemblies, in different implementations, include a base cutter assembly (or “base cutter”), feed rollers, cutting drums, stalk collectors, and extractor fans etc.

To actively harvest crops, the sugarcane harvester gathers and processes material from rows of sugarcane plants. In the case of one type of sugarcane harvester, the gathered sugarcane stalks are cut into billets that move through a loading elevator to an elevator discharge, where the cut sugarcane billets are discharged to a collector, such as the sugarcane wagon. Leaves, trash, and other debris are separated from the billets and ejected onto the field.

The sugarcane, once cut, forms what is known as a “mat” of sugarcane. The sugarcane harvester feeds the mat to a chopping section where it is chopped, including the stalk which is cut into segments. The sugarcane harvester advances the billets along with crop residue (e.g., leafy material, such as leaves, roots, and field debris etc.) to a primary extractor that separates at least a portion of the crop residue from the billets. The primary extractor includes a fan assembly having a motor and blades to clean the sugarcane, that is, to remove the crop residue from the sugarcane billets. The removed crop residue is discharged to the ground or to a collection wagon.

The primary extractor also typically includes a replaceable metal wear ring surrounding the fan assembly. The wear ring is typically a cylindrical steel ring. The crop residue or crop debris is drawn upwardly by the fan and passes between the fan blades and the wear ring into the hood above the fan assembly. The crop debris typically circulates in the hood and ultimately exits the outlet of the hood.

The primary extractor is a large consumer of energy and any improvement in efficiency of the primary extractor is desirable.

### SUMMARY OF THE DISCLOSURE

The present disclosure provides an improved wear ring design including a laterally directed exit opening in the wear ring itself which improves flow of crop debris through the wear ring and to the hood outlet.

In one embodiment a wear ring for an extractor for a sugarcane harvester includes a cylindrical wall including a full height portion circumscribing at least one-half of a circumference of the cylindrical wall and an arcuate exit opening defined in a reduced height portion of the cylindrical wall. A guide chute is attached to the cylindrical wall and extends laterally outward from the exit opening.

In another embodiment an extractor for a sugarcane harvester includes a housing including an inlet and an outlet, the inlet configured to receive a stream of chopped sugarcane including crop debris and billets, and the outlet configured to discharge the crop debris. A fan assembly is located in the housing and includes a plurality of fan blades coupled to a spindle. A wear ring surrounds the fan blades, the wear ring including a cylindrical wall, the cylindrical wall including a full height portion circumscribing at least one-half of a circumference of the cylindrical wall and an exit opening defined in an arcuate reduced height portion of the cylindrical wall, the exit opening being oriented towards the outlet of the housing.

### BRIEF DESCRIPTION OF THE DRAWINGS

The above-mentioned aspects of the present invention and the manner of obtaining them will become more apparent and the invention itself will be better understood by reference to the following description of the implementations of the disclosure, taken in conjunction with the accompanying drawings.

FIG. 1 illustrates a side elevational view of a work vehicle, and more specifically, of an agricultural vehicle such as a sugarcane harvesting machine.

FIG. 2 illustrates a side sectional view of a primary extractor of the sugarcane harvesting machine.

FIG. 3 is an enlarged side sectional view of the primary extractor of FIG. 2.

FIG. 4A is a perspective view of a first embodiment of a wear ring.

FIG. 4B is an elevation section view of the wear ring of FIG. 4A taken along line 4B-4B.

FIG. 4C is a schematic plan view of the wear ring of FIGS. 4A-4B.

FIG. 5A is a perspective view of a second embodiment of a wear ring.

FIG. 5B is an elevation section view of the wear ring of FIG. 5A taken along line 5B-5B.

FIG. 5C is a schematic plan view of the wear ring of FIGS. 5A-5B

FIG. 6A is a perspective view of a third embodiment of a wear ring.

FIG. 6B is an elevation section view of the wear ring of FIG. 6A taken along line 6B-6B.

FIG. 6C is a schematic plan view of the wear ring of FIGS. 6A-6B

FIG. 7A is a perspective view of a fourth embodiment of a wear ring.

FIG. 7B is an elevation section view of the wear ring of FIG. 7A taken along line 7B-7B.

FIG. 7C is a schematic plan view of the wear ring of FIGS. 7A-7B

FIG. 8 is a perspective view of a fifth embodiment of a wear ring.

FIG. 9 is a rear elevation view of the primary extractor of FIG. 2.

FIG. 10 is a schematic elevation section view of an alternative embodiment of a wear ring with an adjustable angle guide chute.

FIG. 11 is a schematic plan view of the sugarcane harvester in a field.

FIG. 12 is a schematic elevation view showing the crop debris distribution on the rows and furrows of the field of FIG. 11.

### DETAILED DESCRIPTION

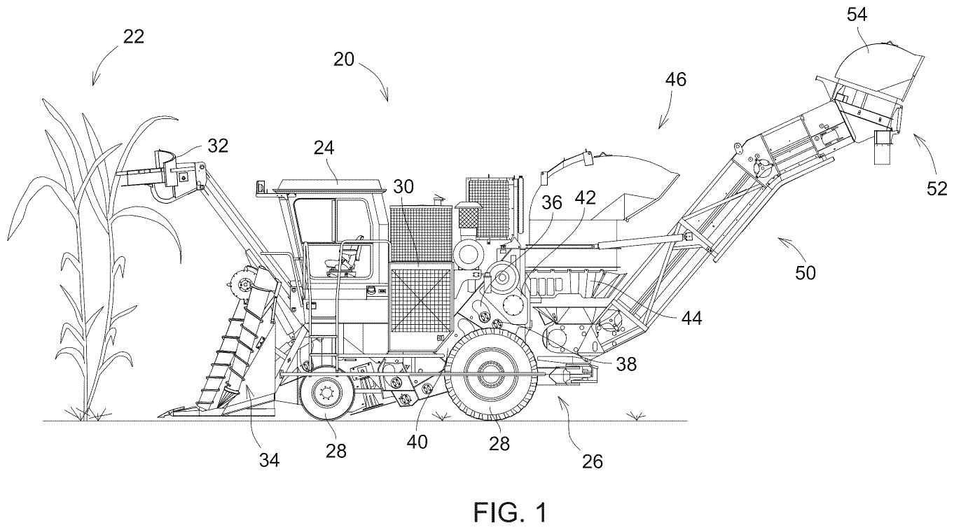

FIG. 1 illustrates a side view of a sugarcane harvester 20 adapted to cut sugarcane 22, with the front of the harvester 20 facing to the right. Accordingly, certain components of the harvester 20 may not be visible in FIG. 1. The harvester 20 includes a cab 24 located on a main frame 26 that is supported by wheels 28 configured to move the harvester along rows of sugarcane 22. An engine is located within an engine housing 30 that moves the wheels 28 along a field to continually cut the sugarcane 22 for harvesting. In different implementations, the engine also powers various driven components of the harvester 20. In certain implementations, the engine directly powers one or more hydraulic pumps (not shown) and other driven components powered by the hydraulic motors via an embedded hydraulic system (not shown).

A cane topper 32 extends forward of the frame 26 in order to remove the leafy tops of sugarcane plants 22. A set of crop dividers 34 guides the stalks of sugarcane toward internal mechanisms of the harvester 20 for processing. As the harvester 20 moves across a field, sugarcane plants passing between the crop dividers 34 are deflected downward by one or more knockdown rollers before being cut near the base of the plants 22 by a base cutter assembly, as would be understood by one skilled in the art. Rotating disks, guides, or paddles (not shown) on the base cutter assembly further direct the cut ends of the plants upwardly and rearward within the harvester 20 toward successive pairs of upper feed rollers 36 and lower feed rollers 38. The feed rollers 36 and 38 are supported by a feed roller chassis 40 which is supported by the main frame 26. The upper and lower feed rollers 36 and 38 convey the stalks toward a chopper drum module 42 for chopping the stalks into billets.

The chopper drum module 42 includes upper and lower chopper drums that rotate in opposite directions in order to chop the moving stalks into billets, as would be understood by one skilled in the art. The billets, including crop residue, are propelled into a cleaning chamber 44 that is located at the base of a primary extractor 46. The primary extractor 46, in different implementations, includes a fan assembly 64 including a powered fan to clean the billets and to extract the crop residue, trash, and debris from the cleaning chamber 44. A loading elevator 50, with a one end located at the bottom of the cleaning zone 44, conveys the cleaned billets upward to a discharge location 52, below a secondary extractor 54, where the billets are discharged into a truck, a wagon, a container, or other receptacle that collects the discharged billets. The secondary extractor 54 separates the crop residue from the cut stalk to clean the cut stalk.

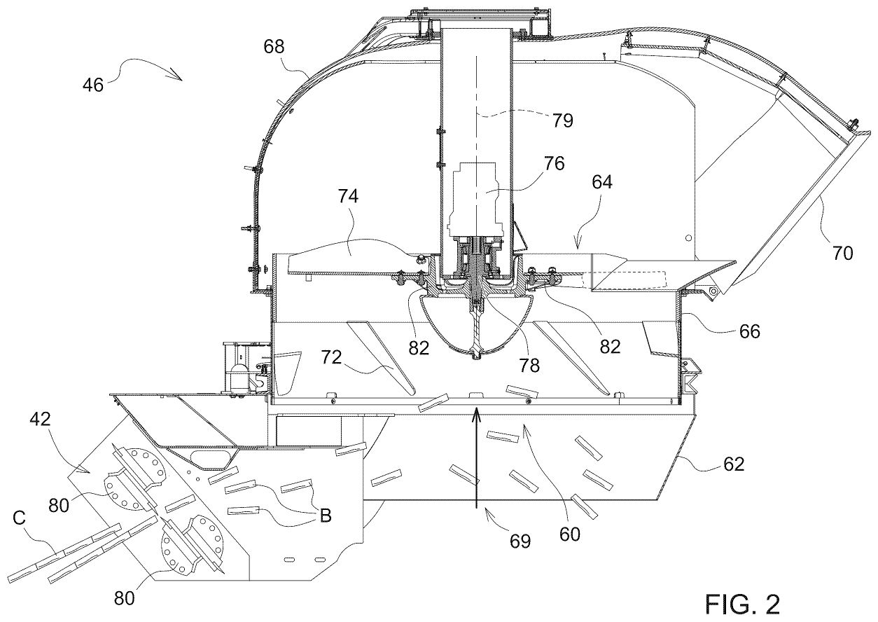

FIG. 2 illustrates a cross section through the chopper drum module 42 and the primary extractor 46. The chopper drum module 42 cuts the crop and the primary extractor 46 receives the cut crop from the chopper drum module 42 and generally separates the cut crop by way of a crop cleaner, which will be described in greater detail below. The crop cleaner may include any suitable mechanism for cleaning the cut crop, such as a fan (as in the illustrated construction that will be described below), a source of compressed air, a rake, a shaker, or any other mechanism that discriminates various types of crop parts by weight, size, shape, etc. in order to separate extraneous plant matter from billets. The primary extractor 46, in different implementations, includes any combination of one or more of a cleaning chamber 60, a cleaning chamber housing 62, a crop cleaner such as a fan assembly 64, a fan enclosure 66, and an extractor hood 68 having an opening 70. The fan enclosure 66 is coupled to the cleaning chamber housing 62 that in at least one implementation includes deflector vanes 72, which are fixed at a predetermined position with respect to the fan enclosure.

The fan assembly 64 includes a plurality of blades 74 driven by a fan motor 76 having a spindle 78 driving the fan blades 74. The angle of incidence of each of the fan blades 74 may be adjustable relative an axis of rotation 79, i.e. motor axis (see FIG. 2), of the motor 76 that rotates the fan blades.

The chopper drum module 42 includes counter-rotating drum cutters 80 with overlapping blades for cutting the stalks of crop, such as cane C, into billets B, which are pieces of the stalk. In other constructions, the chopper drum module 42 includes any suitable blade or blades for cutting the stalks of crop. The crop also includes dirt, leaves, roots, and other plant matter, which will be collectively referred to herein as crop debris, which are also cut in the chopper drum module 42 along with the cane C. The chopper drum module 42 directs a stream of the cut crop (cut stalks, or billets B, and crop debris) to the cleaning chamber 60, which is generally defined by the cleaning chamber housing 62, the fan enclosure 66, and/or the extractor hood 68

The extractor hood 68, coupled to the fan enclosure 66, includes a domed shape, or other suitable shape, and includes the opening 70 angled out from the harvester 20 and facing slightly down onto a field. In some constructions, the opening 70 is generally perpendicular to the driveshaft 78. The hood 68 directs cut crop through the opening 70 to the outside of the harvester 20, e.g., for discharging a portion of cut crop removed from the stream of cut crop back onto the field. The hood 68 may also be referred to as an extractor housing 68.

The fan assembly 64 of FIG. 2 is an axial flow fan which is mounted in the cleaning chamber 60 to clean the sugarcane mat by separating the cut billets from the crop debris. In one implementation, the fan assembly 64 is in the form of an extractor fan having axial flow fan blades 74 radiating out from, and joined to, a motor hub 82. In the illustrated construction, the fan assembly 64 is configured to draw air and extraneous plant matter from the cleaning chamber 60. Inlet airflow 69 generally flows into the cleaning chamber 60 in both axial flow patterns parallel to the motor axis 79 and in helical flow patterns around the motor axis 79.

In other implementations, the fan assembly 64 is configured to blow rather than extract, i.e., to blow or push the air through the cleaning chamber 60 to clean the sugarcane mat by measuring leaf content and/or billet loss. The fan assembly 64, in different implementations, includes other types of fans with other types of blades, such as a centrifugal fan, amongst others.

The motor 76, such as a hydraulic motor, includes the drive shaft 78 operatively coupled to the fan blades 74. For example, the drive shaft 78 may be keyed to the hub 82 or operatively coupled in other suitable ways to drive the fan blades 74. In other implementations, the motor 76 is electric, pneumatic, or any other suitable type of motor, engine, or a prime mover, to drive the fan blades 74.

The function of the guide vanes 72 in the fan 64, i.e. an axial flow fan, is to reduce or eliminate the air spin in the airflow entering or exiting the fan blades 74 and in return reducing the rotational energy losses. Guide vanes can be placed either on the inlet or outlet side of the airflow depending on the application and duct geometry. As seen in FIG. 2, the guide vanes are located on the inlet side.

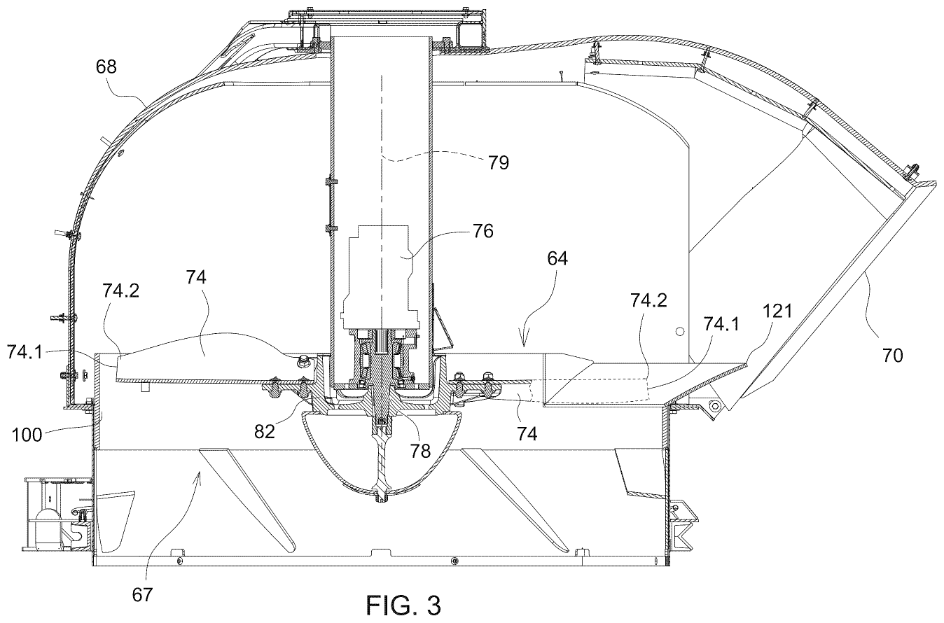

FIG. 3 is an enlarged view of the primary extractor 46. As previously noted, the extractor 46 includes the hood 68 which may also be referred to as an extractor housing 68. The hood 68 includes the inlet 67 configured to receive the sugarcane matt including crop debris and billets B, and the outlet 70 configured to discharge the crop debris. The fan assembly 64 is located within the hood 68 and includes the plurality of fan blades 74 coupled to the spindle 78. A wear ring 100 is received in the inlet 67 of the hood 68 and surrounds the fan blades 74. The wear ring 100 is a replaceable component typically constructed of steel sheet metal, and it absorbs the bulk of the wear due to the crop debris passing upward between the tips of the blades 74 and the wear ring 100. This prolongs the life of the hood 68 which is typically constructed of fiberglass, plastic or the like. Furthermore, reducing the number of recirculation cycles of the crop debris in the upper chamber of the hood 68 will significantly increase the life of both the hood 68 and the wear ring 100. Additionally, a more even discharge profile of crop debris will create more even wear within the hood 68. Shielding the blade tips from inner walls of the first portion of the hood prevent debris from being emitted radially directly into the hood walls and forces the debris upwards in a helical rotating pattern. This also prolongs the life of the hood.

Previously wear rings have been constructed as simple cylindrical rings. With the prior art wear rings all of the crop debris must flow upward past the fan blades 74 into the interior of the hood 68 where it typically circulates around the axis 79 of the fan assembly 64 multiple times and then exits through the outlet 70 in an airborne stream of crop debris.

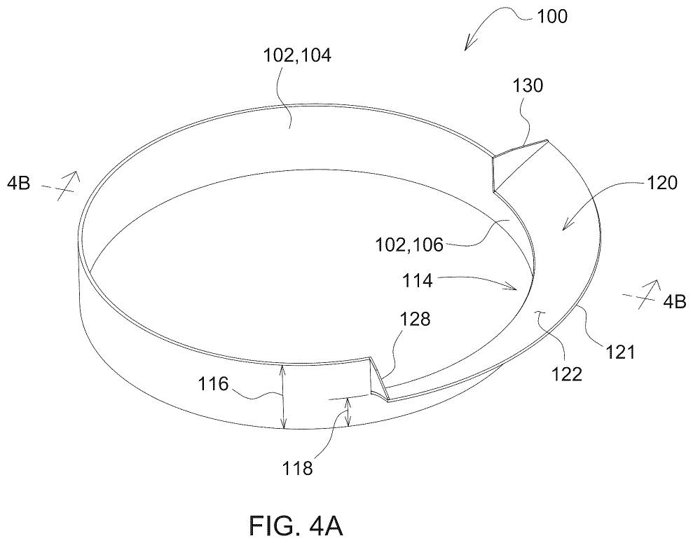

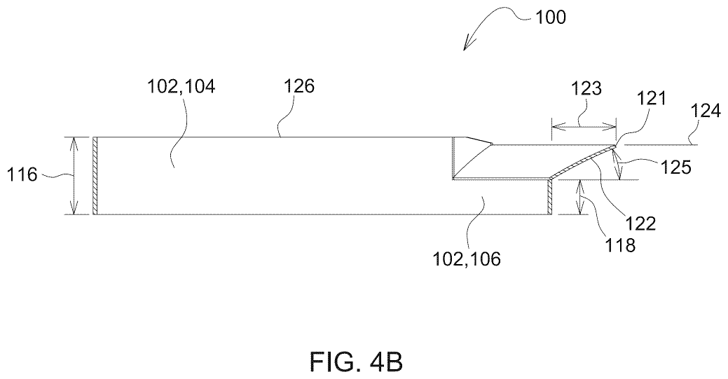

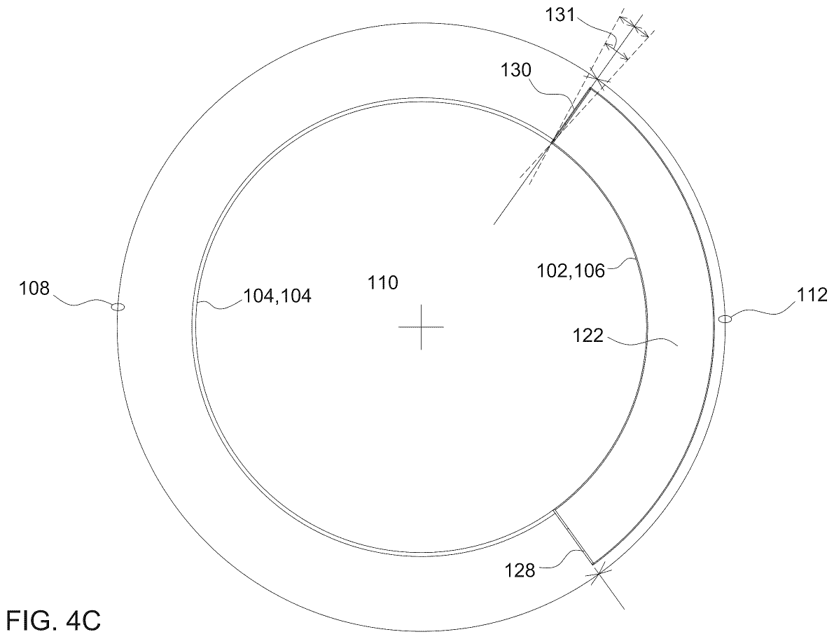

As shown for example in FIGS. 4A-4C, the present disclosure provides an improved wear ring 100 including a cylindrical wall 102 which includes a full height portion 104 and a reduced height portion 106. As best seen in the plan view of FIG. 4C, in the embodiment of FIGS. 4A and 4B the full height portion 104 circumscribes an angle 108 about a central axis 110 of the cylindrical wall 102. The reduced height portion 106 circumscribes an angle 112 about the central axis 110.

As will be seen, in all of the embodiments disclosed herein the full height portion 104 circumscribes an angle 108 equal to at least one-half of a circumference of the cylindrical wall 102. In the embodiment of FIG. 4C, the angle 108 is approximately 270 degrees.

The reduced height portion 106 of the cylindrical wall 102 defines an exit opening 114 of the wear ring 100. As is further discussed below, the exit opening 114 is directed towards the outlet 70 of the hood 68 so that the stream of crop debris may flow through the exit opening 114 and then through the outlet 70.

The full height portion 104 has a full height 116. The full height preferably extends at least to the top blade tip height. The reduced height portion 106 has a reduced height 118. In one embodiment the reduced height 118 may be at least about 40% of the full height 116. In another embodiment the reduced height 118 may be at least about 20% of the full height 116.

The wear ring 100 may also include a guide chute 120 attached to the cylindrical wall 102 and extending laterally outward from the exit opening 114 towards the outlet 70 of the hood 68. The guide chute 120 guides crop debris flowing out the exit opening 114 towards the outlet 70 of the hood 68. The guide chute 120 may include at least a portion 122 which is upwardly tapered as best seen in FIGS. 4A and 4B. For example, the guide chute 120 may include a central frusto-conical shaped portion 122. The upwardly tapered portion 122 may extend to an elevation 124 substantially equal to the full height 116 of the top edge 126 of the full height portion 104 of the cylindrical wall 102. By extending the upwardly tapered portion to an elevation equal to or at least as high as the full height 126, the exit opening 114 is effectively blocked laterally so that debris cannot fly directly radially outward from the fan assembly 64, thus providing an important safety function. The guide chute 120 may extend to an elevation higher than the top edge 126 of the full height portion 104.

The elevation of the guide chute 120 relative to the fan blades 74 may also be considered. Each fan blade 74 has a radially outer tip 74.1. The tip 74.1 has a highest elevation at what may be described as an upper corner 74.2 of the fan blade 74. The guide chute 120 has an upper edge 121 which may project upward to an elevation at least as high as an elevation of the upper corners 74.2 of the fan blade tips 74.1 so that the guide chute 120 radially shields the fan blade tips 74.1. This may be described as having an upper edge 121 projecting upward to an elevation at least as high as a highest elevation of fan blade tips 74.1 so that the guide chute radially shields the fan blade tips. This will aid in preventing the fan blades 74 from slinging rocks or other dangerous objects directly radially outward through the hood opening 70.

The guide chute 120 may also include first and second chute end walls 128 and 130 defining first and second circumferential ends of the guide chute 120. As will be seen, the first and second chute end walls 128 and 130 may take different forms in the various embodiments disclosed herein. In the embodiment of FIGS. 4A-4C the first and second end walls 128 and 130 extend substantially radially from the cylindrical wall 102. As used herein when an angle is described as “about” a certain value it will be understood as being within a range of plus or minus 10 degrees of the stated value. By “substantially radially” it is meant that the end walls extend from the cylindrical wall 102 within a range 131 of plus or minus 10 degrees from a radial line from the axis 110, as schematically shown in FIG. 4C.

As further seen in FIG. 4C, the angle 112 circumscribed by the reduced height portion 106 of the cylindrical wall 102 may be in a range of from about 30 degrees to about 130 degrees, and more preferably in a range of from about 90 degrees to about 120 degrees. In another embodiment the angle 112 may be in a range of from about 30 degrees to about 60 degrees. In another embodiment the angle 112 may be in a range of from about 20 degrees to about 45 degrees.

For a typical primary extractor 46, the wear ring 102 may have a diameter in a range of from 4 feet to 8 feet. In one embodiment the wear ring 102 may have a diameter of 5 feet.

As best seen in FIG. 4B, the guide chute 120 and particularly the frusto-conical shaped portion 122 thereof may extend laterally from the cylindrical wall 102 a distance 123 which may be at least equal to the full height 116 of the cylindrical wall 102.

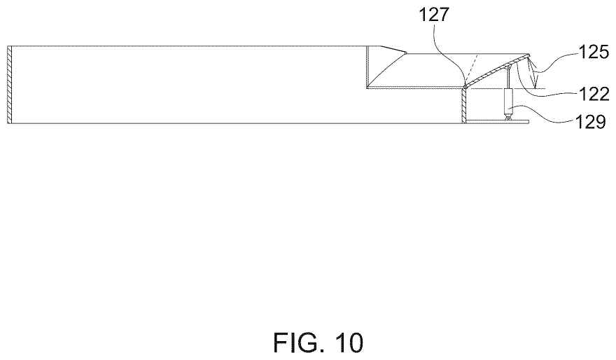

As further seen in FIG. 10, an angle 125 of the frusto-conical portion 122 relative to a horizontal plane may be in a range of from about 30 degrees to about 60 degrees. As further shown in FIG. 10, the frusto-conical portion 122, or a portion thereof may be formed as a flap pivotally connected to cylindrical wall 102 at pivot 127, and the angle 125 may be adjusted via an actuator 129.

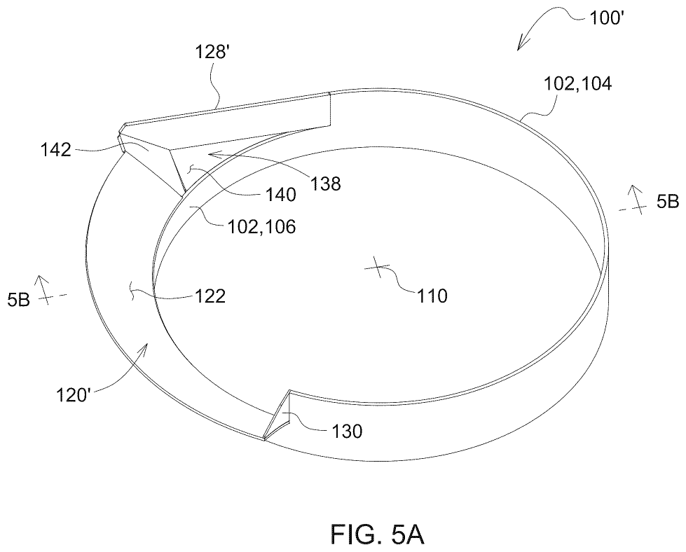

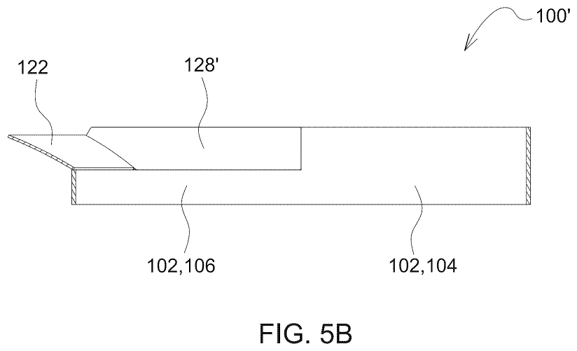

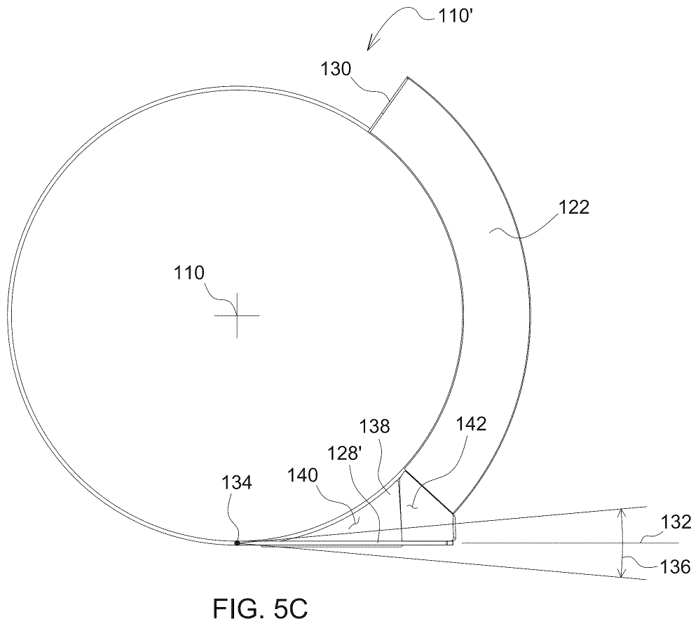

Another embodiment of the wear ring is shown in FIGS. 5A-5C, and is designated as 100′. Those features of wear ring 100′ that are substantially the same as the analogous features of wear ring 100 of FIGS. 4A-4C carry the same identifying numbers and their description will not be repeated. In the embodiment of FIGS. 5A-5C the first chute end wall 128′ now extends substantially tangentially from the cylindrical wall 102. As schematically shown in the plan view of FIG. 5C, the first chute end wall 128′ extends substantially along a line 132 forming a tangent with the cylindrical wall 102 at the base 134 of the first chute end wall 128′. By “substantially tangentially” it is meant that the end wall 128′ extends from the cylindrical wall 102 within a range 136 of plus or minus 10 degrees from the tangential line 132, as schematically shown in FIG. 5C.

When using a substantially tangentially extending chute end wall such as 128′, that chute end wall may be joined to the frusto-conical portion 122 by an end pan portion 138 including a floor 140 and a lip 142 which join the chute end wall 128′ to the frusto-conical portion 122.

The use of an asymmetrical wear ring design like that of FIGS. 5A-5C may be desirable because of the inherent tendency of the stream of crop debris exiting the outlet 70 to be skewed towards the left side of the hood 68 if the fan assembly is rotating counter-clockwise when viewed from above.

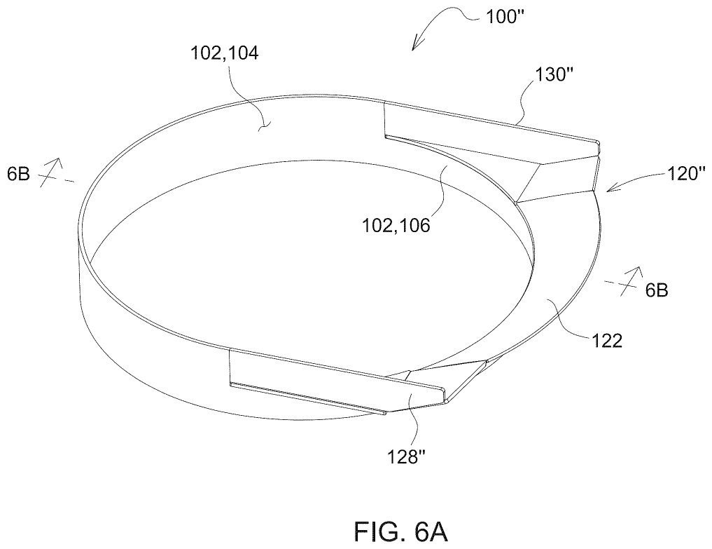

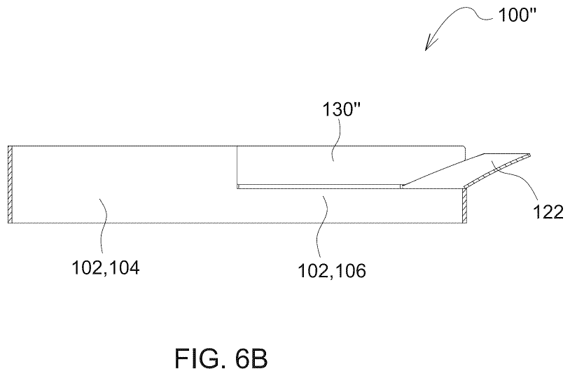

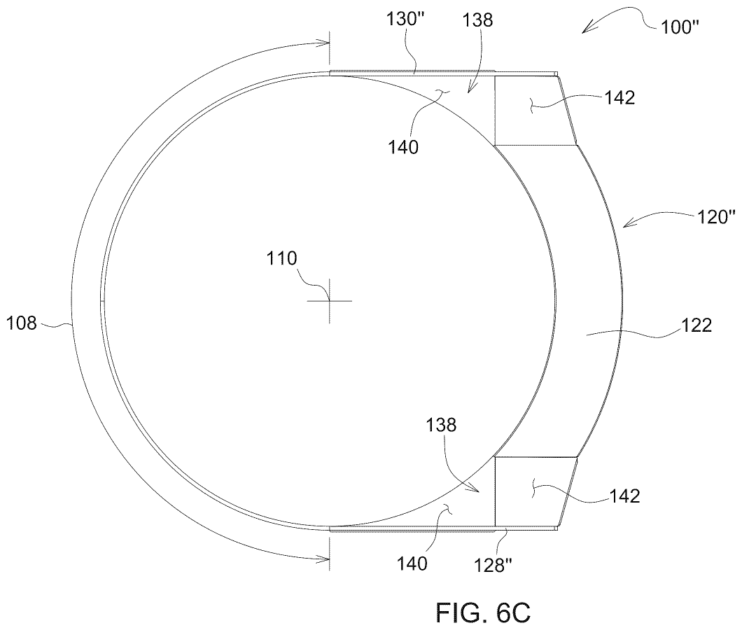

FIGS. 6A-6C show a further embodiment of a wear ring 100″ in which both of the first and second chute end walls 128″ and 130″ extend substantially tangentially from the cylindrical wall 102. As is best seen in the schematic plan view of FIG. 6C, the first and second chute end walls 128″ and 130″ extend substantially parallel to each other. The angle 108 circumscribed by the full height portion 104 of the cylindrical wall 102 is now about 180 degrees. Thus the angle 112 circumscribed by the reduced height portion 106 is also about 180 degrees. The guide chute 120″ of FIGS. 6A-6C can also be described as subtending an angle of about 180 degrees about the central axis 110. Two end pan portions 138 join each of the chute end walls 128″ and 130″ with the frusto-conical portion 122 of the guide chute 120″.

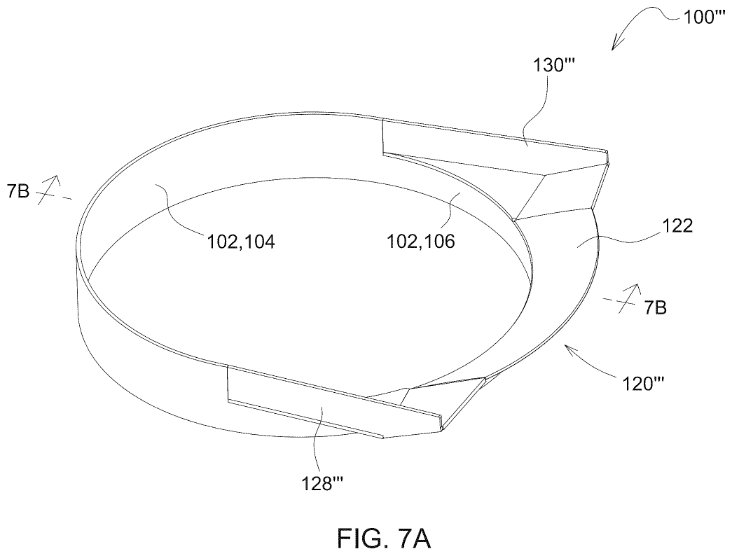

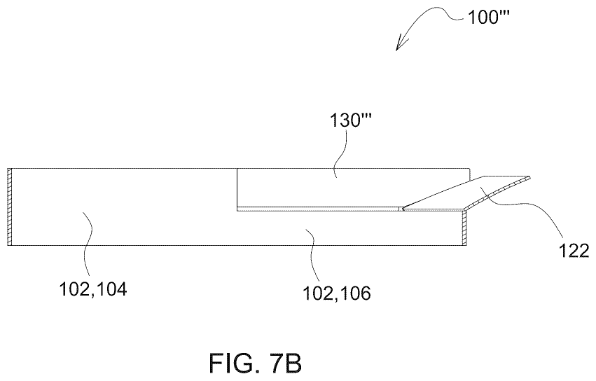

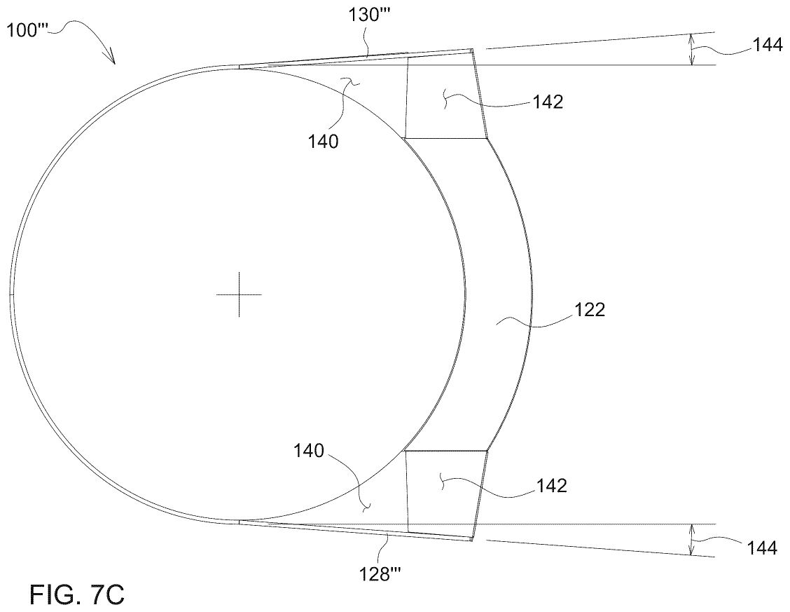

FIGS. 7A-7C show a further embodiment of the wear ring 100′″ in which both of the first and second chute end walls 128′″ and 130′″ begin at base points substantially 180 degrees apart, and the first and second chute end walls 128′″ and 130′″ flare outward away from each other as they extend laterally away from the cylindrical wall 102. As best shown in the schematic plan view of FIG. 7C, each of the chute end walls 128′″ and 130′″ flares outward from a tangential line by a flare angle of about 10 degrees. Again, end pan portions 138 join each of the chute end walls 128′″ and 130′″ with the frusto-conical portion 122 of the guide chute 120′″.

The embodiment of FIGS. 7A-7C may be described as having the reduced height portion 106 of the cylindrical wall 102 subtending an angle 112 of about 180 degrees about the central axis 110 and as having a total flare angle equal to two times the angle 144, that total flare angle being in a range of from 10 degrees to 90 degrees.

It is further noted that although the examples of the chute end walls 128, 130, 128′, 130′, 128″, 130″, 128′″ and 130′″ are all shown herein as being straight walls, it will be understood that the chute end walls could also be curved or segmented in plan view.

The wider openings of the guide chutes of the embodiments of FIGS. 6A-6C and 7A-7C, provide still further improvement in flow of the stream of crop debris out of the exit opening 114 as compared to the embodiments of FIGS. 4A-4C and 5A-5C.

It is further noted that although the wear ring 100 has been described herein as a component of the primary extractor 46, the wear ring 100 may also be used in the secondary extractor 54.

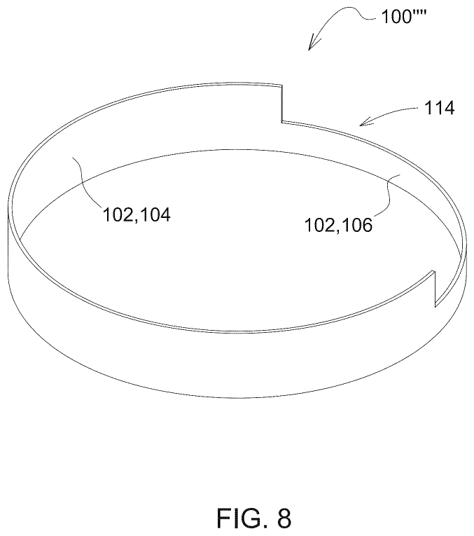

FIG. 8 is a schematic perspective view of a further embodiment of the wear ring 100″″ which does not include the guide chute 120. In the embodiment of FIG. 8, the exit opening 114 is simply defined by the open space above the reduced height portion 106 of the cylindrical wall 102.

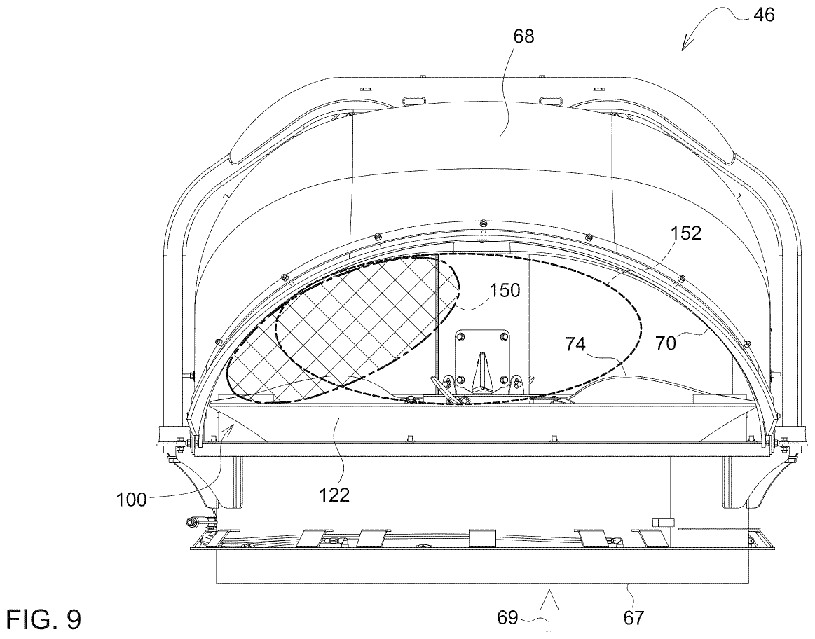

FIG. 9 is a schematic rear elevation view of the upper portion of the primary extractor 46, including the hood 68 and its outlet 70. Possible flow paths of the crop debris exiting the outlet 70 are indicated by the dashed elliptical areas 150 and 152. The smaller elliptical area 150 shown towards the left side of the outlet 70 is representative of the flow path of the stream of crop debris using a typical prior art cylindrical wear ring without any exit opening 114. The larger more centrally located elliptical area 152 is schematically representative of the wider more centrally located flow path provided by the exit opening 114 and associated guide chute 120 of the present disclosure. It is believed that this improved width and location of the flow path is due at least in part to the more direct path that much of the crop debris may take directly from the inlet 67 through the exit opening 114 to the outlet 70 without that crop debris recirculating in the upper portion of the hood 68, or at least with a reduction in such recirculation. Basically, this design reduces the “duct resistance” and further promotes a more streamlined, direct flow path that is more centered with less recirculation.

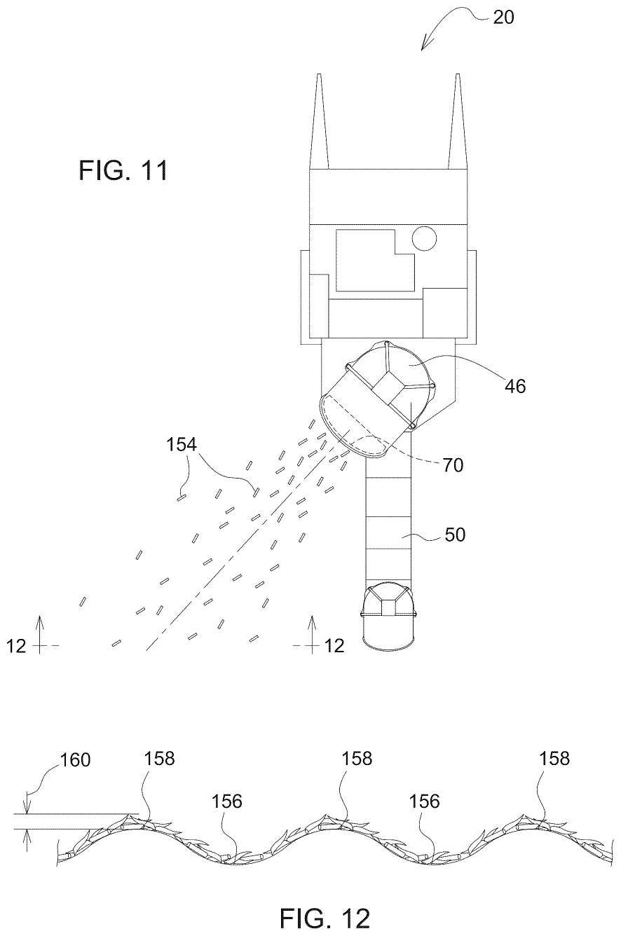

FIG. 11 is a schematic plan view showing the sugarcane harvester 20 operating in a field to cut sugarcane. A stream 154 of crop debris is shown exiting the outlet 70 of hood 68. As will be understood by those skilled in the art, the hood 68 is pivotally mounted on the extractor 46 so that the hood 68 and the position of outlet 70 may be aimed in a desired direction relative to the travel direction of the sugarcane harvester 20. For example the stream 154 may be directed to one side of the sugarcane harvester 20 as seen in FIG. 11. Also, the rotational position of the wear ring 100 within the hood 68 may be adjusted so as to further direct the stream 154 to one side or the other of the outlet 70.

The wider distribution of the stream 154 of crop debris represented by the elliptical area 152 may result in a wider and thinner stream 154 as compared to the prior art. FIG. 12 schematically illustrates a cross-section of the field surface taken along line 12-12 of FIG. 11. By directing that wider and thinner stream 154 laterally into a furrow 156 between rows 158 of the sugarcane, a thinner layer 160 of crop debris is created on top of the rows 158. The bulk of the crop debris is directed into the furrows 156.

By providing a thinner overall layer of crop residue projected onto the field by the sugarcane harvester 20, improved subsequent crop growth is provided without the need for, or with reduced need for, any secondary processing of the crop debris on the ground surface.

The reduction in recirculation of the crop debris within the hood 68 and the reduced restriction of air flow out of the hood 68 may also provide reduced power consumption by the extractor fan assembly 64. A power reduction of as much as 20% may result from the use of the wear ring 100 described above. Further benefits of such geometries may be seen if coupled with optimized guide vane angles and extractor hood shapes; those features in tandem with the improved wear ring disclosed herein can provide reduced crop debris recirculation within the hood and increased extractor efficiencies.

Thus, it is seen that the apparatus and methods of the present disclosure readily achieve the ends and advantages mentioned as well as those inherent therein. While certain embodiments have been illustrated for the purpose of the present disclosure numerous changes may be made by those skilled in the art, which changes are encompassed within the scope and spirit of the present claims.

What is claimed is:

1. A wear ring for an extractor for a sugarcane harvester, comprising:
a cylindrical wall including a full height portion circumscribing at least one-half of a circumference of the cylindrical wall and an arcuate exit opening defined in a reduced height portion of the cylindrical wall; and
a guide chute attached to the cylindrical wall and extending laterally outward from the exit opening.

2. The wear ring of claim 1, wherein:
the guide chute is upwardly tapered; and
the guide chute includes first and second chute end walls defining first and second circumferential ends of the guide chute.

3. The wear ring of claim 2, wherein:
the chute end walls extend upward to an elevation at least as high as an elevation of the full height portion of the cylindrical wall.

4. The wear ring of claim 2, wherein:
at least one of the first and second chute end walls extends substantially radially from the cylindrical wall.

5. The wear ring of claim 4, wherein:
the other of the first and second chute end walls extends substantially tangentially from the cylindrical wall.

6. The wear ring of claim 2, wherein:
both of the first and second chute end walls extend substantially radially from the cylindrical wall; and
the guide chute subtends an angle in a range of from about 30 degrees to about degrees about a central axis of the cylindrical wall.

7. The wear ring of claim 2, wherein:
both of the first and second chute end walls extend substantially tangentially from the cylindrical wall.

8. The wear ring of claim 7, wherein:
the first and second chute end walls extend substantially parallel to each other.

9. The wear ring of claim 2, wherein:
the reduced height portion of the cylindrical wall subtends an angle of about 180 degrees about a central axis of the cylindrical wall; and
the first and second chute end walls flare away from each other by a total flare angle in a range of from 10 degrees to 90 degrees.

10. The wear ring of claim 2, wherein:
the reduced height portion of the cylindrical wall has a height at least about 20% of a full height of the full height portion.

11. The wear ring of claim 1, wherein:
at least a portion of the guide chute is frusto-conical in shape.

12. The wear ring of claim 11, wherein:
the guide chute includes first and second chute end walls defining first and second circumferential ends of the guide chute;
the frusto-conical shaped portion of the guide chute is centrally located between the first and second chute end walls; and
the guide chute further includes first and second end pan portions joining the first and second chute end walls, respectively, to the centrally located frusto-conical shaped portion.

13. The wear ring of claim 1, wherein:
the guide chute extends laterally from the cylindrical wall a distance at least equal to a height of the full height portion of the cylindrical wall.

14. An extractor for a sugarcane harvester, comprising:
a housing including an inlet and an outlet, the inlet configured to receive a stream of chopped sugarcane including crop debris and billets, and the outlet configured to discharge the crop debris;
a fan assembly located in the housing and including a plurality of fan blades coupled to a spindle; and
a wear ring surrounding the fan blades, the wear ring including a cylindrical wall, the cylindrical wall including a full height portion circumscribing at least one-half of a circumference of the cylindrical wall and an exit opening defined in an arcuate reduced height portion of the cylindrical wall, the exit opening being oriented towards the outlet of the housing.

15. The extractor of claim 14, wherein:
the wear ring further includes a guide chute attached to the cylindrical wall and extending laterally outward from the exit opening towards the outlet of the housing, wherein at least a portion of the guide chute is upwardly tapered.

16. The extractor of claim 15, wherein:
the fan blades each include a fan blade tip; and
the guide chute includes an upper edge projecting upward to an elevation at least as high as an elevation of a highest elevation of the fan blade tips so that the guide chute radially shields the fan blade tips.

17. The extractor of claim 15, wherein:
the guide chute includes first and second chute end walls defining first and second circumferential ends of the guide chute;
one of the first and second chute end walls extends substantially radially from the cylindrical wall; and
the other of the first and second chute end walls extends substantially tangentially from the cylindrical wall.

18. The extractor of claim 15, wherein:
the guide chute includes first and second chute end walls defining first and second circumferential ends of the guide chute;
both of the first and second chute end walls extend substantially radially from the cylindrical wall; and
the guide chute subtends an angle in a range of from about 30 degrees to about 130 degrees about a central axis of the cylindrical wall.

19. The extractor of claim 15, wherein:
the guide chute includes first and second chute end walls defining first and second circumferential ends of the guide chute; and
both of the first and second chute end walls extend substantially tangentially from the cylindrical wall.

20. The extractor of claim 19, wherein:
the guide chute subtends an angle of about 180 degrees about a central axis of the cylindrical wall; and
the first and second chute end walls extend substantially parallel to each other.
